(19) United States
(12) Patent Application Publication
(10) Pub. No.: US 2008/0317262 A1
(43) Pub. Date: Dec. 25, 2008

(54) Microphone Having an Output Signal Amplifier

(76) Inventor: Jens Schlichting, Hannover (DE)

Correspondence Address: KENYON & KENYON LLP, ONE BROADWAY, NEW YORK, NY, 10004, US

(21) Appl. No.: 11/884,408

(22) PCT Filed: Feb. 8, 2006
(86) PCT No.: PCT/EP06/50771

§ 371 Date: Aug. 14, 2008

(30) Foreign Application Priority Data
Feb. 18, 2005 (DE) 10 2005 007 623.8

(51) Int. Cl. H04R 3/00

(52) U.S. Cl. 381/113; 381/111

(57) ABSTRACT

A microphone is described including a microphone housing having a microphone capsule disposed therein. The microphone is connected via a microphone cable to an audio system, and has an integrated amplifier that raises the signal output level. The integration of a preamplifier into the microphone advantageously reduces the microphone's susceptibility to interference. In contrast to conventional preamplifiers, the preamplifier does not, or not exclusively, operate as an impedance converter, but instead amplifies the output voltage. As a consequence, the signal-to-noise ratio is advantageously increased even in the presence of interference. The preamplifier can be provided with energy via a battery or accumulator mounted in the microphone, or advantageously from the audio system via additional conductors in the microphone cable.

### FIELD OF THE INVENTION

The present invention relates to a microphone.

### BACKGROUND INFORMATION

A microphone receives, via a membrane, acoustic oscillations in the form of acoustic pressure or an acoustic pressure difference, and converts them into electrical voltage signals. Different categories of microphones are known, such as passive dynamic microphones and condenser microphones, e.g., active electret condenser microphones.

Dynamic microphones, in terms of their operation, utilize the induction law to convert a membrane motion into a change in voltage. The plunger coil microphone is common today. The membrane responds to atmospheric oscillations and guides an electrical conductor through a strong magnetic field. In the conductor, a voltage is induced that behaves proportionally to the speed at which the membrane moves. Dynamic microphones do not require a supply voltage, are robust, and operate with low distortion even at high volumes. Because of the substantially larger moving mass of the membrane and plunger coil as compared with condenser microphones, the transient response behavior of a plunger coil microphone is slower.

Condenser microphones are the most commonly used microphones. They are found in a very wide variety of presentations, since this term refers only to the converter principle. In a condenser microphone, a membrane and a fixed counterelectrode function together as a condenser whose capacitance changes in accordance with the oscillations of the membrane. Because the membrane has a very low mass, it responds particularly precisely to the atmospheric oscillations. The weight of the membrane here is approximately twenty times less than in the case of dynamic microphones. This is a very substantial reason for the high quality of condenser microphones. The condenser microphone offers high quality, but requires an operating voltage in order to maintain the condenser charge and to power an internal amplifier in the microphone. This amplifier functions merely as an impedance converter, since condenser microphones are so high-resistance that they cannot be connected to a cable without electrically active adaptation. The subgroup of the electret condenser microphones can also be operated without an external voltage supply, using an internal battery.

German Patent No. DE 695 06 727 describes a low-noise amplifier for microphones. The amplifier described therein creates a low-noise impedance converter with a low input capacitance that uses field-effect transistors as active components. The circuit is suitable as a preamplifier for converters, in particular for condenser microphones using the electret principle.

A disadvantage of condenser microphones is their very weak output signal, with a typical signal output level from 0.5 mV RMS to 2 mV RMS. Because of this very low signal level, signal transmission from the microphone to an external microphone preamplifier is very susceptible to interference. For utilization, for example, in a tour bus, the multifarious interference signals together with microphone cable lengths of several meters thus lead to a poor signal-to-noise ratio and therefore to clearly audible interference during microphone announcements. In specific cases, this interference cannot be eliminated even by laborious shielding measures.

Because of the low output voltage of the microphone, it has downstream from it an amplifier, which in the case of tour buses is usually disposed in the audio unit at the other end of the microphone cable. The output voltage depends substantially on the type of converter in the microphone, i.e., whether it is a condenser microphone or a dynamic microphone, and on the acoustic pressure of the sound source, the microphone distance, and the room acoustics. For condenser microphones, a gain of at least 20 dB is necessary.

A disadvantage of this downstream placement of the amplifier, however, is that the interference noise that is introduced is thereby also amplified.

### SUMMARY

It is an object of the present invention to describe a microphone that can be operated with less susceptibility to interference.

An example microphone according to the present invention, having a microphone housing with a microphone capsule, the microphone being connected via a microphone cable to an audio system, has an integrated amplifier that raises the signal output level.

The integration of a preamplifier into the microphone advantageously reduces the microphone's susceptibility to interference. In contrast to conventional preamplifiers, the preamplifier does not, or not exclusively, operate as an impedance converter, but instead amplifies the output voltage. As a consequence, the signal-to-noise ratio is advantageously increased even in the presence of interference. The preamplifier can be provided with energy via a battery or accumulator mounted in the microphone, or advantageously from the audio system via additional conductors in the microphone cable.

Also advantageous is the configuration of the amplifier as a symmetrical amplifier having corresponding low-frequency outputs (NF+, NF.−). This further reduces the microphone's susceptibility to interference.

The integrated amplifier can advantageously make available, in addition to the increase in output level, an impedance conversion that is necessary for condenser microphones.

It is furthermore advantageous to provide a supplementary microphone switch on the microphone for switching the source to the microphone.

A further advantage of the example microphone according to the present invention is that the microphone can be configured as both a dynamic microphone and a condenser microphone.

### BRIEF DESCRIPTION OF THE DRAWINGS

The present invention will be explained below in more detail with reference to several exemplary embodiments, making reference to the attached figures. A condenser microphone is explained as an exemplary embodiment. Be it noted that the microphone according to the present invention is not limited to the “condenser” converter type, but can also be applied, for example, to dynamic microphones.

FIG. 1 shows a block diagram of the example microphone according to the present invention having an integrated preamplifier.

FIG. 2 shows a block diagram of the example microphone according to the present invention having an integrated preamplifier and an additional microphone switch.

### DETAILED DESCRIPTION OF EXAMPLE EMBODIMENTS

In condenser microphones, the mechanical oscillations of the membrane is converted into electrical oscillations. The so-called low-frequency technique has proven successful for conversion. In the low-frequency circuit, the microphone capsule is charged via a resistor to a fixed DC voltage. This can be between 40 V and 200 V. When an acoustic wave strikes the membrane, the capacitance of the condenser changes in the same rhythm as the acoustic waves, as a function of the spacing of the condenser plates. This results in a charge equalization and thus in a corresponding AC voltage at the resistor. The voltage drop at the resistor is proportional to the magnitude of the change in capacitance and the magnitude of the applied DC voltage. For a condenser capacitance of 20 pF to 100 pF (depending on microphone type), the resistor must have a value between 80 MΩ and 400 MΩ. A long electrical lead cannot be connected to such a high-resistance source. When a signal source has, for example, a high impedance, i.e., a high resistance, this means that if a load having a low resistance is connected, a high current flows and overloads the source, since its high electrical resistance allows only a small current. Condenser microphone converters therefore cannot be connected to cables without electrical adaptation. Adaptation is accomplished by way of a preamplifier in the condenser microphone.

This conventional preamplifier is substantially only an impedance converter. Power is supplied to it in most cases via the microphone cable, but can also be provided via built-in batteries. A suitable impedance converter is in turn high-resistance on its input side, while it is low-resistance (i.e. can supply a large current) on its output side. An impedance converter of this kind can be implemented using a transistor in a collector circuit.

Microphones of this kind are connected to the external microphone amplifier via two-conductor shielded microphone cables. Two different types of energy feed are known: so-called phantom power or center feed, and “T-power” (Tonaderspeisung). Phantom feed offers lower susceptibility to interference and easy connection. With sound conductor feed, the operating voltage is present in parallel with the signal on both conductors of the cable. With phantom feed, the positive pole of the feed voltage is connected to both conductors via two identical feed resistors.

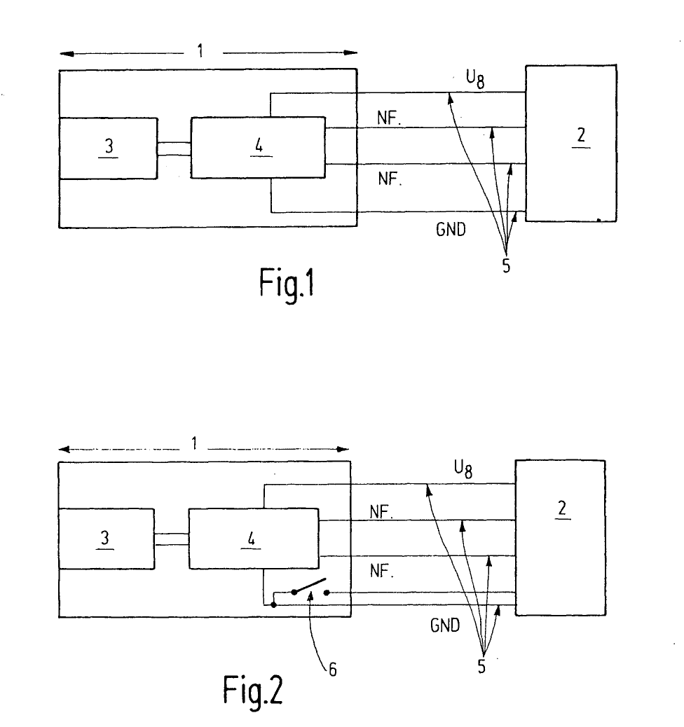

FIG. 1 shows a microphone circuit according to an example embodiment of the present invention. In a microphone having a microphone housing 1, a microphone capsule 3 is connected to an amplifier 4. Amplifier 4 is supplied with a voltage UB from an audio system 2 via a cable. Energy supply (UB, GND) to the integrated microphone preamplifier can occur via additional conductors in microphone cable 5 as shown in FIG. 1, from system 2, or by way of a battery or accumulator contained in the microphone. Amplifier 4 delivers the amplified signal to audio system 2 via leads 5.

In a preferred exemplary embodiment, a symmetrical amplifier having a corresponding output (NF+, NF−) is used. An additional resistance to interference is thereby advantageously achieved.

According to the present invention, microphone preamplifier 4, which is normally disposed in a system 2 such as, for example, a special radio having microphone inputs for tour buses, or a bus audio/video system made up of multiple components, is shifted into microphone housing 1. This preamplifier 4 integrated into the microphone has according to the present invention, for example, a gain factor of 500 (or 54 dB), so that, for example, a signal from the microphone capsule of 1 mV RMS is amplified here to 0.5 V RMS (NF+, NF−). Microphones of the existing art typically have a signal output level of 0.5 mV RMS-2 mV RMS. As a result of the placement of microphone preamplifier 4 directly in the microphone, the signal level is raised to a substantially higher value. The result of this is that the signal-to-noise ratio on the transmission path to the output amplifier is greatly improved. The gain factor depends on the type of microphone used. For condenser microphones, a gain of 20 dB to 30 dB is necessary for loud sound sources such as an orchestra, and between 30 dB and 50 dB for quieter sound sources such as speech. For dynamic microphones, this value is about 20 dB higher. Microphone amplifier 4 allows any gain from 0 dB for high-level sources such as, for example, conductors, to 70 or 80 dB for microphones.

Amplifier 4 can furthermore increase the output level only moderately so that the susceptibility to interference is only audibly reduced, or else it can increase the output level directly to the desired final value. In the latter case, the use of an output amplifier could advantageously be dispensed with.

FIG. 2 shows a further exemplary embodiment of the microphone according to the present invention. Here the microphone has a supplementary microphone switch 6 for switching the source to the microphone.

Amplifier 4 shown in FIGS. 1 and 2 can also, when the condenser type of microphone converter is used, additionally contain an impedance converter.

Audio system 2 can be implemented, for example in tour buses, by a special radio having microphone inputs, or by a bus audio/video system made up of multiple components.

The present invention is not limited to the exemplary embodiments presented here, in particular not to condenser microphones. It is instead possible, by combining and modifying the elements and features described, to achieve further variant embodiments without departing from the scope of the present invention.

1-12. (canceled)

13. A microphone, comprising:
a microphone housing having a microphone capsule, the microphone being connected via a microphone cable to an audio system;
wherein the microphone has an integrated amplifier that raises a signal output level.

14. The microphone as recited in claim 13, wherein the amplifier can be supplied with energy from the audio system via additional conductors in the microphone cable.

15. The microphone as recited in claim 13, wherein the amplifier can be supplied with energy via one of a battery or a accumulator contained in the microphone.

16. The microphone as recited in claim 13, wherein the amplifier is a symmetrical amplifier having outputs.

17. The microphone as recited in claim 13, wherein the amplifier achieves a gain of between 20 and 60 dB.

18. The microphone as recited in claim 13, wherein the amplifier achieves a gain of between 1 and 100 dB.

19. The microphone as recited in claim 13, wherein the amplifier integrated into the microphone encompasses an impedance converter in addition to an increase in output level.

20. The microphone as recited in claim 13, wherein the microphone is a dynamic microphone.

21. The microphone as recited in claim 13, wherein the microphone is a condenser microphone.

22. The microphone as recited in claim 13, wherein the microphone has a supplementary microphone switch adapted to switch a source to the microphone.

23. The microphone as recited in claim 13, wherein the audio system is a radio having microphone inputs.

24. The microphone as recited in claim 13, wherein the audio system is implemented by a combined bus audio/video system made up of multiple components.
